(19) United States
(12) Patent Application Publication
(10) Pub. No.: US 2004/0028021 A1
(43) Pub. Date: Feb. 12, 2004

(54) CDMA telecommunication system

(76) Inventors: Prabodh Varshney, Coppell, TX (US); Hannu Vilpponen, Oulou (FI); Mohammad Borran, Irving, TX (US); Panayiotis Papadimitriou, Irving, TX (US)

Correspondence Address: Docket Clerk, Scheef & Stone, L.L.P., Suite 1400, 5956 Sherry Lane, Dallas, TX, 75225, US

(21) Appl. No.: 10/608,923

(22) Filed: Jun. 27, 2003

Related U.S. Application Data
(60) Provisional application No. 60/398,493, filed on Jul. 25, 2002.

(51) Int. Cl. H04B 7/216; H04Q 11/00; H04L 12/50

(52) U.S. Cl. 370/342; 370/288; 370/366

(57) ABSTRACT

A system and method for the efficient transmission of information in a code division multiple access (CDMA) wireless telecommunication system. The rate of reliable transmission is increased by implementing an orthogonal frequency-division multiplexing (OFDM) scheme in, for example, a direct-spread CDMA network, resulting in a multi-carrier CDMA (MC-CDMA) system. Information (such as voice and data), is encoded, divided, and spread across the frequency domain, rather than in the time domain as in traditional CDMA; the allowable transmission bandwidth is divided into a number of carriers. Using this scheme, a number of loading parameters such as code rate, data rate, and the number of streams into which the encoded data is divided may be varied to increase the performance of the system. Application of the variable loading parameter may be a function of channel quality, such as the presence of noise or the channel fading state.

### CLAIM OF BENEFIT (35 U.S.C. § 119(e))

This Application claims the benefit of U.S. Provisional Application No. 60/398,493, filed Jul. 25, 2002.

### FIELD OF THE INVENTION

The present invention relates generally to radio telephony, and more specifically to a system and method for efficient code division multiple access (CDMA) communication using wideband multi-carrier CDMA (MC-CDMA).

### BACKGROUND OF THE INVENTION

The now ubiquitous telecommunication instruments commonly called cellular telephones (or simply “cell phones”) are actually mobile radios having a transmitter and a receiver, a power source, and some sort of user interface. They are referred to as cell phones because they are designed to operate within a cellular network. Despite being radios, they typically do not communicate directly with each other. Instead, these mobile telephones communicated over an air interface (radio link) with numerous base stations located throughout the network's coverage area. The network base stations are interconnected in order to route the calls to and from telephones operating within the network coverage area.

FIG. 1 is a simplified block diagram illustrating the configuration of a typical cellular network 100. As may be apparent from its name, the network coverage area (only a portion of which is shown in FIG. 1) is divided into a number of cells, such as cells 10 through 15 delineated by broken lines in FIG. 1. Although only six cells are shown, there are typically a great many. In the illustrated network, each cell has associated with it a base transceiver station (BTS). Generally speaking, BTS 20 is for transmitting and receiving messages to and from any mobile stations (MSs) in cell 10; illustrated here as MS 31, MS 32, and MS 33, via radio frequency (RF) links 35, 36, and 37, respectively. Mobile stations MS 31 through MS 33 are usually (though not necessarily) mobile, and free to move in and out of cell 10. Radio links 35-37 are therefore established only where necessary for communication. When the need for a particular radio link no longer exists, the associated radio channels are freed for use in other communications. (Certain channels, however, are dedicated for beacon transmissions and are therefore in continuous use.) BTS 21 through BTS 25, located in cell 11 through cell 15, respectively, are similarly equipped to establish radio contact with mobile stations in the cells they cover.

BTS 20, BTS 21, and BTS 22 operate under the direction of a base station controller (BSC) 26, which also manages communication with the remainder of network 100. Similarly, BTS 23, BTS 24, and BTS 25 are controlled by BSC 27. In the network 100 of FIG. 1, BSC 26 and 27 are directly connected and may therefore route calls directly to each other. Not all BSCs in network 100 are so connected, however, and must therefore communicate through a central switch. To this end, BSC 20 is in communication with mobile switching center MSC 29. MSC 29 is operable to route communication traffic throughout network 100 by sending it to other BSCs with which it is in communication, or to another MSC (not shown) of network 100. Where appropriate, MSC 29 may also have the capability to route traffic to other networks, such as a packet data network 50. Packet data network 50 may be the Internet, an intranet, a local area network (LAN), or any of numerous other communication networks that transfer data via a packet-switching protocol. Data passing from one network to another will typically though not necessarily pass through some type of gateway 49, which not only provides a connection, but converts the data from one format to another, as appropriate.

Note that packet data network 50 is typically connected to the MSC 29, as shown here, for low data rate applications. Where higher data rates are needed, such as in 1xEV-DO or 1xEV-DV networks, the packet data network 50 is connected directly to the BSCs (26, 27), which in such networks are capable of processing the packet data. The downlink peak data rate for a 1xEV-DV system, for example, is 3.0912 Mbps.

The cellular network 100 of FIG. 1 has several advantages. As the cells are relatively small, the telephone transmitters do not need a great deal of power. This is particularly important where the power source, usually a battery, is housed and carried in the cell phone itself In addition, the use of low-power transmitters means that the mobile stations are less apt to interfere with others operating nearby. In some networks, this even enables frequency reuse, that is, the same communication frequencies can be used in non-adjacent cells at the same time without interference. This permits the addition of a larger number of network subscribers. In other systems, codes used for privacy or signal processing may be reused in a similar manner.

At this point, it should also be noted that as the terms for radio telephones, such as “cellular (or cell) phone” and “mobile phone” are often used interchangeably, they will be treated as equivalent herein. Both, however, are a sub-group of a larger family of devices that also includes, for example, certain computers and personal digital assistants (PDAs) that are also capable of wireless radio communication in a radio network. This family of devices will for convenience be referred to as “mobile stations” (regardless of whether a particular device is actually moved about in normal operation).

In addition to the cellular architecture itself, certain multiple access schemes may also be employed to increase the number of mobile stations that may operate at the same time in a given area. In frequency-division multiple access (FDMA), the available transmission bandwidth is divided into a number of channels, each for use by a different caller (or for a different non-traffic use). A disadvantage of FDMA, however, is that each frequency channel used for traffic is captured for the duration of each call and cannot be used for others. Time-division multiple access (TDMA) improves upon the FDMA scheme by dividing each frequency channel into time slots. Any given call is assigned one or more of these time slots on which to send information. More than one voice caller may therefore use each frequency channel. Although the channel is not continuously dedicated to them, the resulting discontinuity is usually imperceptible to the user. For data transmissions, of course, the discontinuity is not normally a factor.

Code-division multiple access (CDMA) operates somewhat differently. Rather than divide the available transmission bandwidth into individual channels, individual transmissions are spread by applying a unique spreading code. By spreading each transmission in a different way, each receiver (i.e. mobile station) processes only that information intended for it and ignores other transmissions. The number of mobile stations that can operate in a given area is therefore limited by the number of spreading sequences available, rather than the number of frequency bands. The operation of a CDMA network is normally performed in accordance with a protocol referred to as IS-95 (interim standard-95) or, increasingly, according to its third generation (3 G) successors, such as those sometimes referred to as 1xEV-DO and 1xEV-DV, the latter of which provides for the transport of both data and voice information.

FIG. 2 is a flow diagram illustrating the basic steps involved in sending a CDMA transmission according to the prior art. At START it is assumed that information from an information source (such as a caller's voice) is available and that a connection has been established with a receiving node. At step 205, the audible voice information is sampled and digitally encoded. The encoded information is then organized into frames (step 210). Error detection bits are then added (step 215) so that the receiver can evaluate the integrity of the received data. The resulting signal is then convolutionally encoded (step 220). Block interleaving is then performed (step 225) on the resulting signal to further enhance the receiver's ability to reconstruct the bit stream with a minimum of error. The interleaved signal is then spread by a pseudonoise (PN) code (step 230), a long code is applied (step 235) and a Walsh code is used to spread the wave form and provide channelization (step 240). I and Q short codes are added (step 245) and the results filtered (step 250) before being combined and spread (step 255), then amplified (step 260) for transmission.

As alluded to above, mobile stations and the network they are a part of are presently being used to carry an increasingly large amount of traffic. Not only is the number of ordinary voice calls increasing, but so is the number of other uses to which mobile stations can be put. Short message service (SMS) messaging and instant messaging are becoming more popular, faxes and emails can be sent through mobile stations, and World Wide Web pages can be downloaded. Portable personal computers can be equipped to send through the network data files such as spreadsheets, word processing documents, and slide presentations. All of this information may enter and leave the network infrastructure through the air interface, which has a limited bandwidth by its nature and varying levels of interference and distortion. This means that more efficient methods of radio transmission offering higher data rates at satisfactory quality levels are increasingly in demand. The present invention presents a solution that addresses this growing need.

### SUMMARY OF THE INVENTION

In one aspect, the present invention is a system for wireless communication using code division multiple access (CDMA), including an encoder for encoding information, a modulator for modulating the encoded information stream, and a transmitter for transmitting the modulated signal stream according to an orthogonal frequency division multiplexing (OFDM) scheme that allows for variation in one or more of a number of loading parameters such as the number of users, the coding rate and the data rate.

In another aspect, the present invention is a method of transmitting a CDMA signal, including the steps of encoding the information, modulating the encoded signal onto a carrier, dividing the modulated signal into a plurality of streams, spreading each of the plurality of streams with a spreading code, modulating the spread streams in an OFDM modulator, and determining whether to apply a variable loading parameter. This determination may be made according to predetermined factors relating to the location and expected use of the transmitter, and may be adjustable based on traffic conditions, channel interference, or similar factors.

### BRIEF DESCRIPTION OF THE DRAWINGS

For a more complete understanding of the present invention, and the advantages thereof, reference is made to the following drawings in the detailed description below:

FIG. 1 is functional block diagram illustrating the relationship of selected components of a typical CDMA telecommunication network, such as one that might advantageously employ the system and method of the present invention.

FIG. 2 is a functional block diagram illustrating an exemplary process of transmitting and receiving a communication signal in the network of FIG. 1.

FIG. 3 is a functional block diagram illustrating the relationship of selected components of an MC-CDMA telecommunication system operable according to an embodiment of the present invention.

FIG. 4 is a functional block diagram illustrating selected components of an MC-CDMA transmitter operable according to an embodiment of the present invention.

FIG. 5 is a functional block diagram illustrating selected components of the receiver portion of an embodiment of the present invention.

FIG. 6 is a flow diagram illustrating a method of transmitting a radio signal according to an embodiment of the present invention.

FIG. 7 is a flow chart illustrating a method of receiving a radio signal according to an embodiment of the present invention.

### DETAILED DESCRIPTION

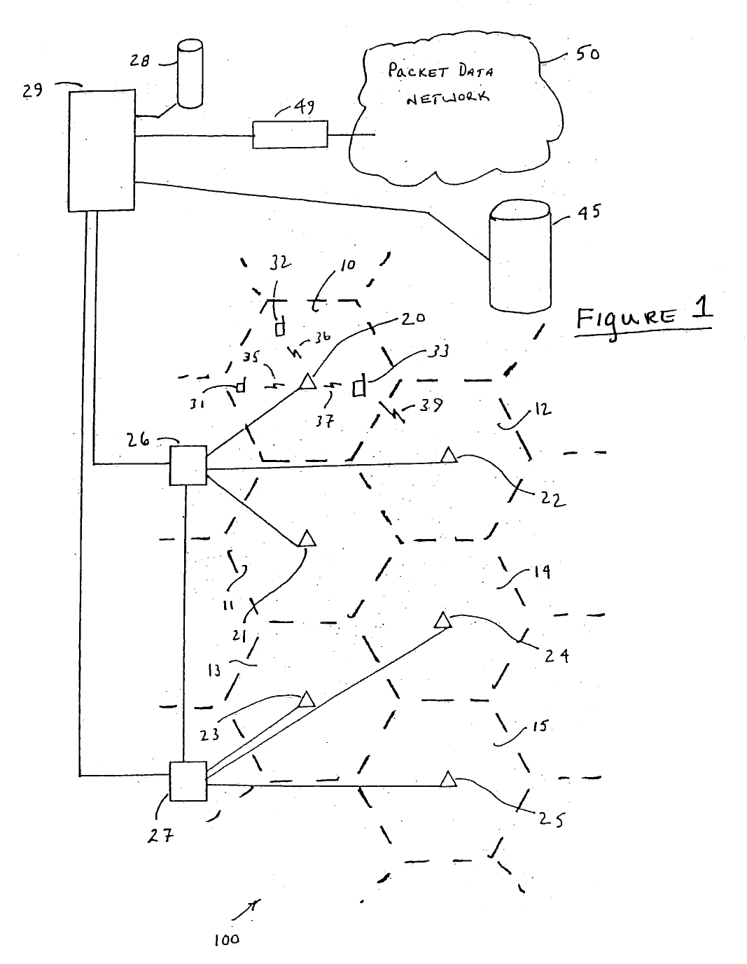

FIGS. 1 through 7, discussed herein, and the various embodiments used to describe the present invention are by way of illustration only, and should not be construed to limit the scope of the invention. Those skilled in the art will understand the principles of the present invention may be implemented in any similar radio telecommunication system, in addition to those specifically discussed herein.

The present invention is directed to a system and method for optimizing code division multiple access (CDMA) communication in a wireless communication system. As described above, in a conventional CDMA system, signals are spread in the time domain prior to transmission. In a multi-carrier CDMA (MC-CDMA) system, in contrast, spreading is done in the frequency domain.

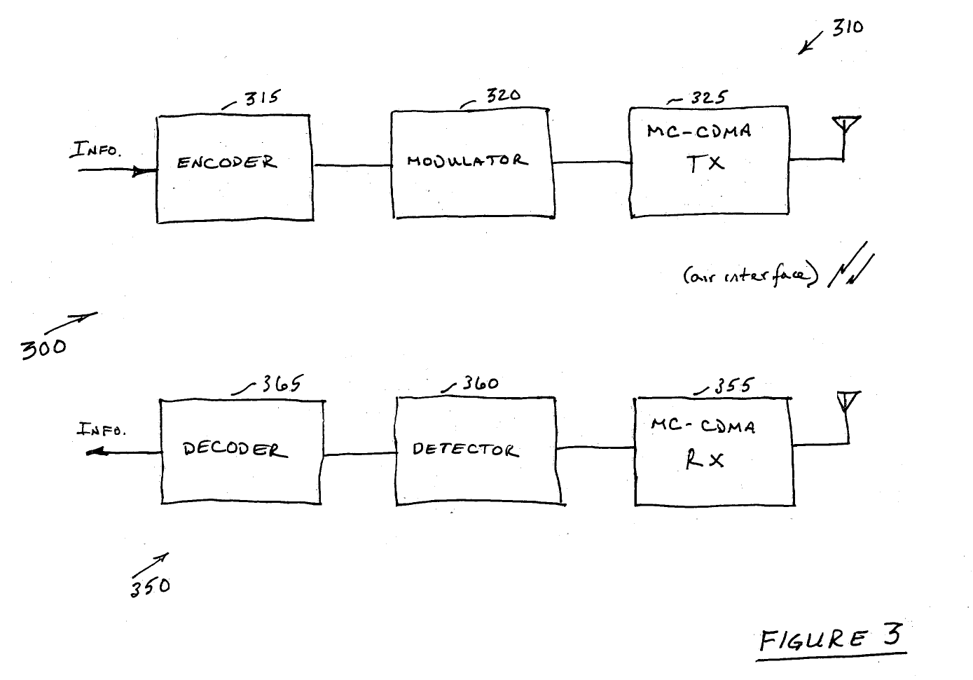

FIG. 3 is a functional block diagram illustrating the relationship of selected components of an MC-CDMA telecommunication system 300 operable according to an embodiment of the present invention. System 300 has a transmit side 310 and a receive side 350. Naturally, there could be any number of transmitters and receivers, but for simplicity only one of each is illustrated. Information, which could be voice or data, is first encoded in encoder 315 according to an encoding scheme such as that currently specified in the 1xEV-DV specification. Other encoding schemes may be acceptable, but it is preferred that the system of the present invention be backward compatible with established systems where feasible. In accordance with an embodiment of the present invention, the coding rate, however, may be varied to adjust for varying conditions, transmitter performance, or other design or environmental factors.

The encoded information is then provided to modulator 320 where it is modulated onto a carrier using, for example, a QPSK or 16QAM modulation scheme. The modulated signal is then provided to an MC-CDMA transmitter 325 for transmission over a selected air-interface channel. The signal transmitted by transmitter 325 is intended to be received by an MC-CDMA receiver 355 in the receiving instrument 350, and the transmitted symbols are detected by detector 360, and finally decoded in decoder 365 so that the transmitted information is recovered on the receiver side. A transmitter and a receiver according to an embodiment of the present invention are described in more detail below.

Note that the transmitter and receiver illustrated in FIG. 3 may be (and generally are) part of a much larger telecommunication system (see, for example, the system of FIG. 1), which uses for communication not only radio transmission, but often wire, optical fiber, and microwave channels as well. Information is frequently sent though the network, and between the network and other networks on such channels. Mobile stations, however, virtually always rely on radio communication to communicate with the rest of the network. This means that the air interface is an important and even indispensable part of the network. Unfortunately, it is generally speaking the most bandwidth limited channel, and the medium most subject to variable distortion, traffic, and interference effects. In this light, it is most advantageous to utilize radio transmitters and receivers that use optimum transmission methods that can be adjusted to these varying conditions, either by location, by individual transmitter, or from time to time as local conditions change.

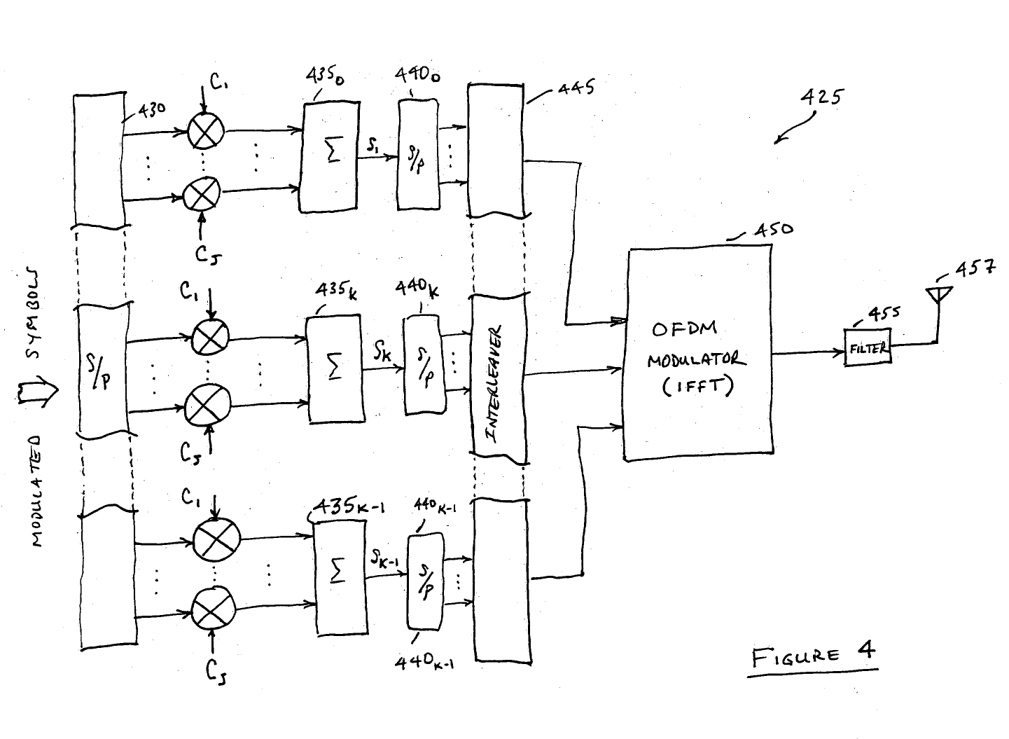

As alluded to above, the transmitter 325 and receiver 355 are designed for use according to an MC-CDMA protocol, which differs in some respects from that used in a conventional CDMA system. FIG. 4 is a functional block diagram illustrating selected components of an MC-CDMA transmitter 425 operable according to an embodiment of the present invention. Initially, modulated symbols provided to the transmitter 425 (see, for example, the transmitter 325 of FIG. 3) are separated using serial-to-parallel converter 430 into K blocks of J streams. The number of streams in each block may be fixed, but in a preferred embodiment the number can be adjusted to account for varying transmission conditions (or other factors). Each of the J streams are spread using a spreading code, here numbered C₁ . . . C_{J}. Naturally, the number of streams J is limited by the number of available unique spreading codes.

The spread streams are provided to a summer 435 (here illustrated as a summer for each block enumerated, respectively, 435₀, 435ₖ, and 435_{K-1}. The resulting symbol streams So through S_{K-1} are passed through S/P converter 440₀, 440ₖ, and 440_{K-1} and then provided to interleaver 445 where they are interleaved. The resulting streams are provided to an orthogonal frequency division multiplexing (OFDM) modulator 450, which according to this embodiment of the invention applies an inverse fast Fourier transform (IFFT) to spread the symbols into frequency bins in the frequency domain. Note that in a preferred embodiment, the transmitter data rate can be varied to adjust for changing conditions. The signal from OFDM modulator 450 is filtered by pulse-shaping filter 455 before being transmitted via antenna 457.

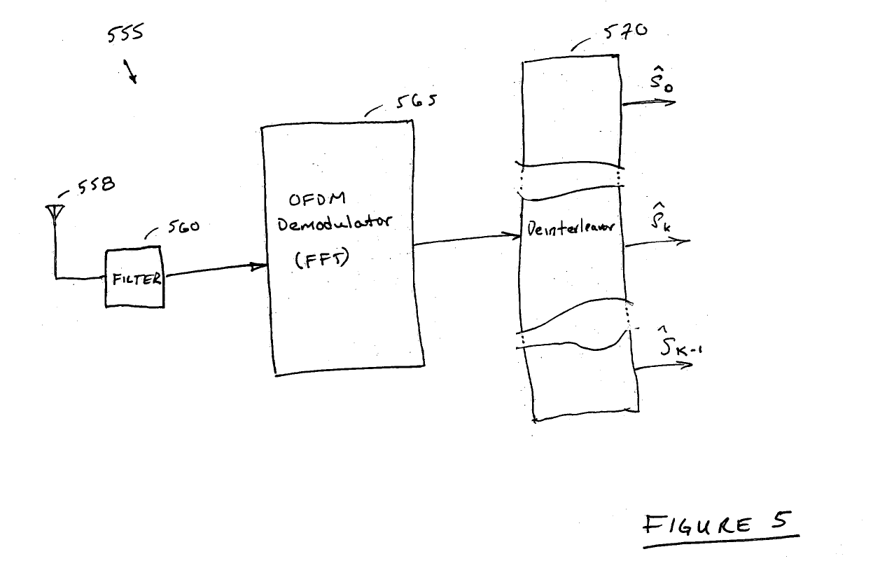

FIG. 5 is a functional block diagram illustrating selected components of the receiver portion 555 of an embodiment of the present invention. The receiver 555 receives a transmitted signal via antenna 558, which provides it to a receive filter 560. The filtered signal is then provided to an OFDM demodulator 565 and demodulated by application of a fast Fourier transform (FFT). The demodulated signal is then provided to an interleaver 570, which deinterleaves the signal into reconstructed streams Ŝ₀ though Ŝ_{K-1} (each associate with a respective transmitted block). The streams Ŝ₀ though Ŝ_{K-1} will then be provided to a detector (see, for example, detector 360 in FIG. 3). In accordance with an embodiment of the present invention, the receiver 555 is operable to process signals transmitted by transmitter 425 (shown in FIG. 4), in which loading parameters such as coding rate, data rate, and streams per block are subject to variation.

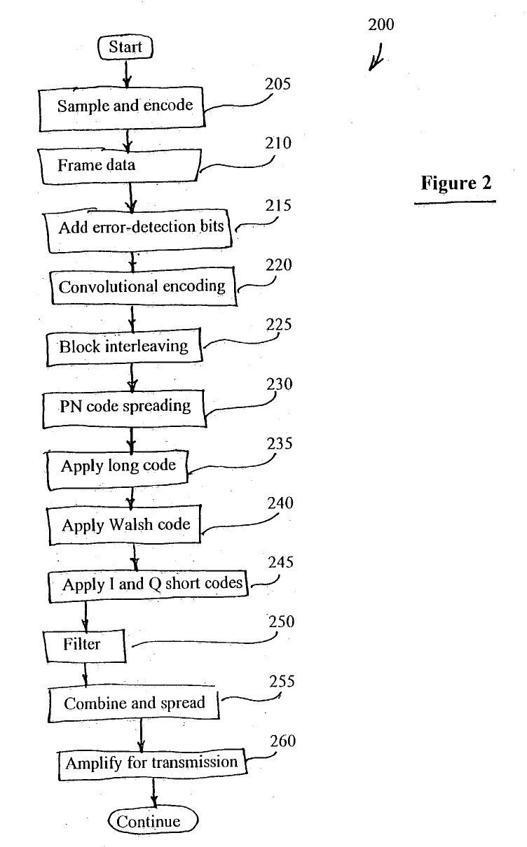

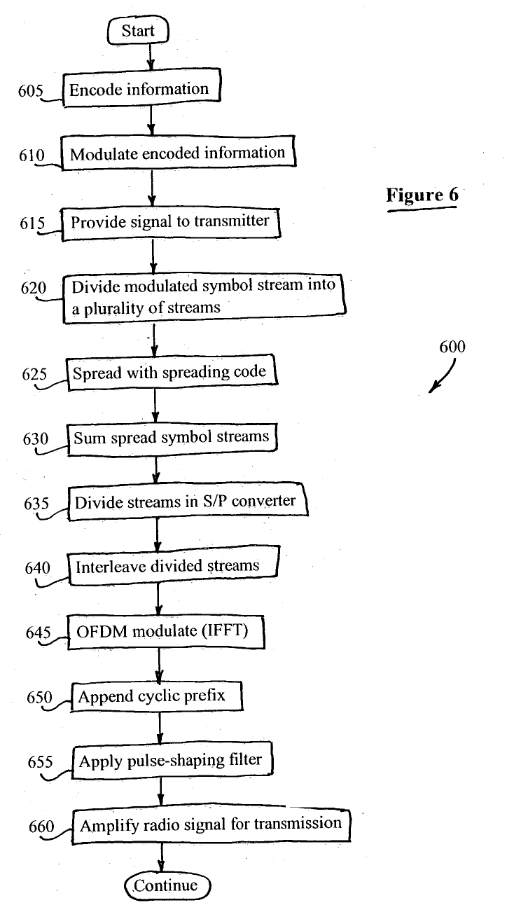

FIG. 6 is a flow diagram illustrating a method 600 of transmitting a radio signal according to an embodiment of the present invention. At START, it is assumed that the required communications equipment, such as that described above in reference to FIGS. 2-5. The method begins at step 605 where the information, such as data or voice information, is encoded using an encoding scheme such as one currently called out in the 1xEv-DV specification. The coding rate may be fixed but is preferably adjustable. The encoded information stream is then modulated onto a carrier (step 610) and the modulated signal provided to an MC-CDMA transmitter step 615.

In the MC-CDMA transmitter, the modulated symbol stream is divided into a plurality of streams (step 620). If there are multiple users, then the modulated symbol streams of all users are divided into a plurality of blocks, with each block having a number of streams. In accordance with one embodiment of the present invention, the number of streams may be varied to account for varying conditions or for other reasons. The streams within each block are then each spread with a spreading code (step 625), preferably using a Walsh-Hadamard code of a predetermined length. The spread streams in each block are then summed (step 630) to form a single spread stream.

In the illustrated embodiment, the spread stream is one of a plurality of spread streams, each associated with a certain block. In this case, the spread stream associated with each block is provided to a serial to parallel (S/P) converter and divided (step 635). The resulting outputs are interleaved (step 640) and provided to an OFDM modulator where the interleaved signals are mapped to a plurality of frequency bins by applying an inverse fast Fourier transform (IFFT) (step 645). A cyclic prefix is then added (step 650) and the symbol stream is passed though a pulse shaping filter (step 655) before it is amplified for transmission (step 660).

The method described above has been found to provide comparable or superior communications when compared with conventional 1xEV-DV or other kinds of CDMA systems. In addition, it has been determined that using variable loading parameters in combination with the method described above provides further improvement in results. In a first embodiment of the present invention, the variable loading parameter is the number of spread streams into which the modulated symbol stream is divided prior to being spread with a spreading code (step 625, described above). Significant reduction inter-symbol interference and a corresponding improvement in performance may be realized by adjusting the number of spread streams to an optimum level.

In another embodiment of the present invention the variable loading factor is the channel coding rate. By strengthening the channel coding rate the system in the MC-CDMA telecommunications system described above, the performance of the system in terms of evaluation factors such as bit error rate (BER) may be significantly improved without sacrificing communication capacity or data rate. In another embodiment, the code rate of the MC-CDMA system is increased such the data rate capability itself is increased.

In yet another embodiment of the present invention, application of one or more variable loading parameters may be combined, to the extent it is consistent to do so. The variable loading factors may also be dynamically adjustable to compensate for varying traffic loads, or for channel conditions such as noise level or fading state.

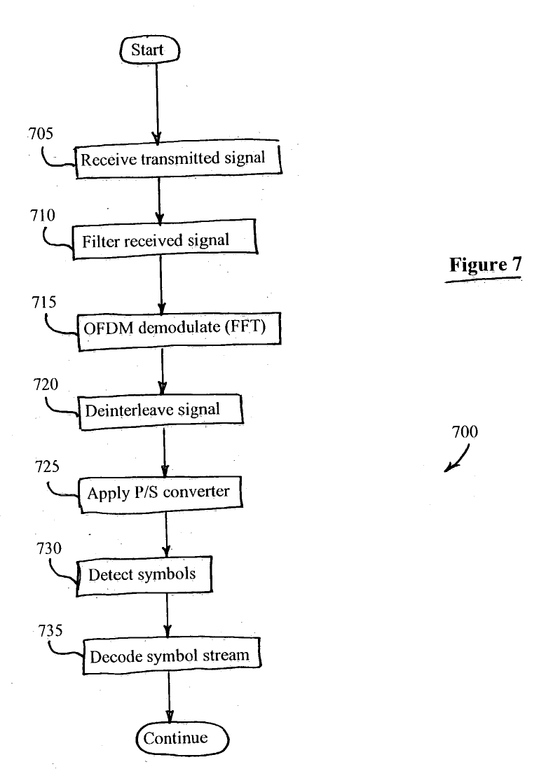

FIG. 7 is a flow diagram illustrating a method 700 of receiving a radio signal according to an embodiment of the present invention. At START is presumed that transmission from a compatible transmitter has already been made according to an embodiment of the present invention. The method begins with the reception of the transmitted signal (step 705). The receiver signal is filtered (step 710) and then the filtered signal is passed through an OFDM demodulator (step 715), which applies a fast Fourier transform (FFT). The demodulated signal is then deinterleaved (step 720) and provided to a parallel-to-serial (P/S) converter (step 725) where it is converted to a plurality of parallel spread streams. (Assuming the parallel spread streams form blocks) each block of spread streams is provided to a detector that attempts to detect the original encoded symbols (step 730). The symbols are then decoded (step 735) to reproduce the originally transmitted information.

The preferred descriptions are of preferred examples for implementing the invention, and the scope of the invention should not necessarily be limited by this description. Rather, the scope of the present invention is defined by the following claims.

What is claimed is:

1. A wireless telecommunication system including an air interface operating according to a code division multiple access (CDMA) scheme, said system comprising:
an encoder for encoding an information stream for transmission;
a modulator for modulating the encoded information stream;
a transmitter operating according to an orthogonal frequency division multiplexing (OFDM) scheme, the transmitter comprising:
at least one serial-to-parallel (S/P) converter for dividing the modulated symbol stream into a plurality of streams;
a plurality of spreaders for spreading each of the plurality of streams with a spreading code;
at least one summer for summing the plurality of spread streams into at least one symbol stream; and
an OFDM modulator for spreading symbol streams in the frequency domain using an inverse fast Fourier transform; and
wherein the transmitter applies at least one variable loading parameter.

2. The system of claim 1, wherein the variable loading parameter is the coding rate.

3. The system of claim 1, wherein the variable loading parameter is the data rate.

4. The system of claim 1, wherein the variable loading parameter is the number of spread streams in the plurality of spread streams provided to the summer.

5. The system of claim 1, wherein the at least one S/P converter divides the modulated symbol stream into a plurality of blocks, each block comprising a plurality of streams.

6. The system of claim 5, wherein the at least one S/P converter comprises a plurality of S/P converters.

7. The system of claim 5, wherein the at least one summer comprises a plurality of summers, each summer for summing the streams associated with at least one of the plurality of blocks.

8. The system of claim 7, further comprising
a plurality of post-summer S/P converters for dividing the symbol stream output of each summer into a plurality of parallel streams; and
an interleaver for receiving and interleaving the parallel-stream output of the plurality of post-summer S/P converters, wherein the output of the interleaver is a plurality of symbol streams that is provided to the OFDM modulator.

9. The system of claim 1, wherein the air interface has a limited transmission bandwidth and application of the variable loading parameter is a function of the bandwidth available for transmission.

10. The system of claim 9, wherein the bandwidth available for transmission is subject to vary over time.

11. The system of claim 1, wherein the air interface is required to carry a varying amount of traffic and application of the variable loading parameter is a function of the current traffic load.

12. The system of claim 1, wherein the air interface is subject to noise affecting the quality of the transmitted information and application of the variable loading parameter is a function of the noise introduced in over the air interface.

13. The system of claim 1, wherein the air interface is subject to channel fading affecting the quality of the transmitted information and application of the variable loading parameter is a function of the fading state.

14. A method for processing an information-bearing signal to be transmitted over an air interface in a CDMA communication network; said method comprising the steps of:
encoding the information;
modulating the encoded signal onto a carrier;
dividing the modulated signal into a plurality of streams;
spreading each of the plurality of streams with a spreading code;
modulating the spread streams in an OFDM modulator; and
determining whether to apply a variable loading parameter.

15. The method of claim 14, wherein the step of determining is performed prior to the encoding step.

16. The method of claim 14, wherein the variable loading parameter is the coding rate.

17. The method of claim 14, wherein the variable loading parameter is the data rate.

18. The method of claim 14, wherein the variable loading parameter is the number of streams created in the dividing step.

19. The method of claim 14, further comprising the step of interleaving the signal prior to the step of modulating the spread streams in an OFDM modulator.

20. The method of claim 14, wherein application of the variable leading parameter is a function of the quality of the air interface.
